(19) United States
(12) Patent Application Publication
(10) Pub. No.: US 2010/0255882 A1
(43) Pub. Date: Oct. 7, 2010

(54) APPARATUS AND A METHOD FOR ARRANGING ELEMENTS ON A DISPLAY

(75) Inventors: Oleg Kozitsyn, Tampere (FI); Mikko Antero Nurmi, Tampere (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 12/417,785

(22) Filed: Apr. 3, 2009

(51) Int. Cl. H04M 1/00; G09G 3/20

(52) U.S. Cl. 455/566; 345/55

(57) ABSTRACT

An apparatus and a method. The apparatus is adapted to display elements on a display of a computing device. The elements have interworking relationships with other elements on the device. The interworking relationships are stored in a memory of the device. The icons are arranged on the display based on the interworking relationships.

### TECHNICAL FIELD

This invention relates to an apparatus and a method for arranging elements on a display.

### BACKGROUND TO THE INVENTION

Mobile phones and other computing devices include home screens which display widgets. Widgets provide a user with access to certain applications and information from certain applications. Widgets may also provide a user with access functions within certain applications. Widgets are arranged on the home screen in order for a user to select and use applications or view relevant information. Widgets are typically arranged manually on the home screen or are arranged randomly.

### SUMMARY OF EXAMPLES OF THE INVENTION

An example of the invention provides an apparatus comprising: a display module adapted to display a plurality of elements on a display of a computing device,; and an interworking module adapted to store relationship information concerning relationships between each of said elements; wherein the display module is further adapted to arrange said elements on said display in accordance with said relationship information.

The relationship information may include interworking information.

The relationship information may include information concerning the number of elements with which an element may interwork.

The interworking information may include pre-stored information regarding an element's ability to interwork with another element.

The interworking information includes information concerning the degree to which a user uses interworking between two elements.

The interworking information may include a layout index.

The elements may represent widgets.

An example of the invention may provide a computing device comprising the apparatus described above, comprising: a display, adapted to display said elements; a memory, adapted to store said display module and said interworking module as instructions; and a processor, adapted to carry out said instructions.

The display may be touch screen display which is an input device to said computing device.

The device may be a mobile phone.

A further example of the invention provides a method comprising: storing relationship information concerning a relationship between each of a plurality of elements; displaying a plurality of said elements on a display, and arranging said elements on said display in accordance with said relationship information.

The relationship information may include interworking information and the method may arrange those elements most suitable for interworking in preference to those less suitable.

The relationship information may include information concerning a number of interworking connections and the method may arrange those elements having the most interworking connections in preference to those with less interworking connections.

A further example of the invention may provide a computer program or suite of computer programs arranged such that when executed by a computer they cause the computer to operate in accordance with the method described above.

A further example of the invention may provide a computer-readable storage medium encoded with instruction that, when executed by a computer, perform: the method described above.

A further example of the invention provides a device substantially as described herein and as shown in FIGS. 1 to 9.

This summary provides examples of the invention which are not intended to be limiting on the scope of the invention. The features of the invention described above and recited in the claims may be combined in any suitable manner. The combinations described above and recited in the claims are not intended to limit the scope of the invention.

Features and advantages associated with the examples of the invention will be apparent from the following description of some examples of the invention.

### BRIEF DESCRIPTION OF THE DRAWINGS

Examples of the invention are hereinafter described with reference to the accompanying figures in which:

FIG. 1 is a mobile device in an example of the invention;

FIG. 2 is a schematic diagram showing some components of the device shown in FIG. 1;

FIG. 3 is a functional diagram showing some components of the device shown in FIG. 1;

FIG. 4 is a further functional diagram showing some components of the device shown in FIG. 1;

FIG. 5 is the display of the device shown in FIG. 1;

FIG. 6 is a table showing adjacency index information and which is stored in the device shown FIG. 1;

FIG. 7 is a further table showing adjacency index information and which is stored in the device shown FIG. 1;

FIGS. 8A to 8F show a flow chart showing a method in an example of the invention; and

FIG. 9 is a further diagram showing the display of the device shown in FIG. 1.

### DESCRIPTION OF EXAMPLES OF THE INVENTION

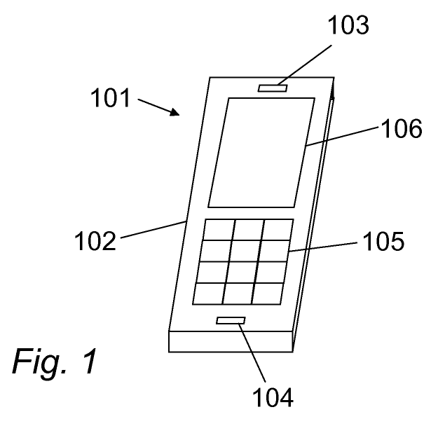

A mobile device 101 in accordance with an example of the invention is shown in FIG. 1. The mobile device 101 comprises an outer casing 102, which includes an earphone 103 and a microphone 104. The mobile device 101 also includes a keypad 105 and a display 106. The keypad 105 enables a user to enter information into the mobile device 101 and instruct the mobile device to perform the various functions which it provides. For example, a user may enter a telephone number, or select another mobile device from a list stored on the mobile device 101, as well as perform functions such as initiating a telephone call. The display 106 may also be a touch-screen and act as an input device for the mobile device 101.

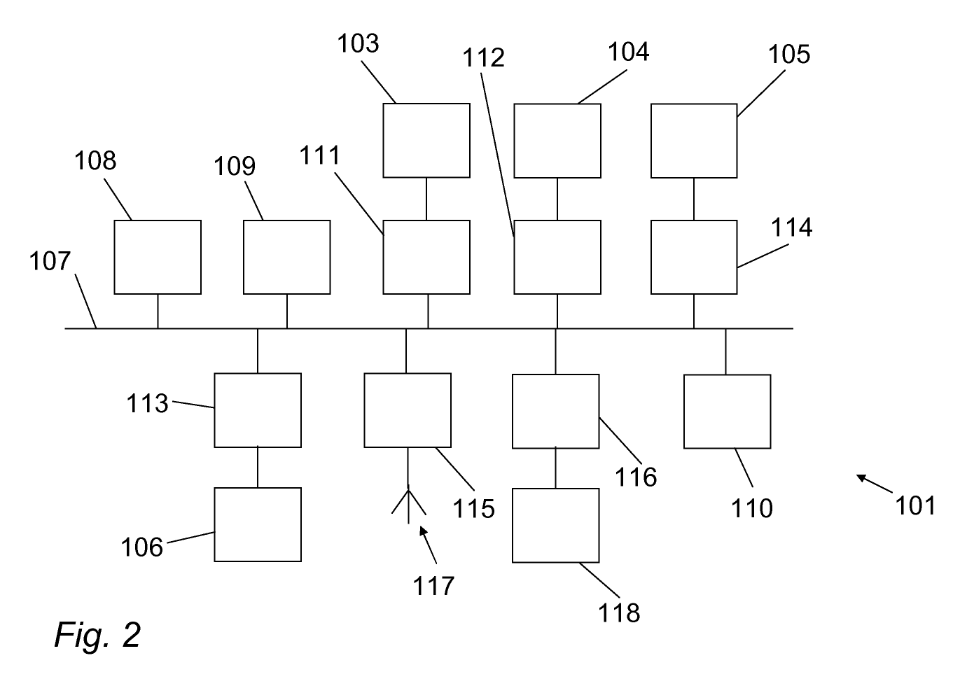

FIG. 2 is a schematic diagram showing the components of the mobile device 101. The components of the mobile device 101 include the earphone 103, the microphone 104, the keypad 105 and the display 106. The mobile device 101 also includes a system bus 107 to which the components are connected and which allows the components to communicate with each other. Here, the components are shown to communicate via a single system bus 107. However, in practice the mobile device may include several buses to connect the various components. The device also includes an application processor 108, a baseband processor 109, memory 110, an earphone controller 111, a microphone controller 112, a display controller 113, and a keyboard controller 114. The device 101 also includes a mobile telephone radio 115 and a storage device controller 116. The application processor 108 is for running an operating system and user applications. The baseband processor 109 is for controlling a telephony stack. The mobile telephone radio 115 is also connected to an antenna 117. The mobile device 101 is arranged to communicate, via radio 117, with a base station of a mobile phone network (not shown). The storage device controller 116 is connected to a storage device 118 which may be an internal hard drive or a removable storage device such as a flash memory card.

This description of the components of a mobile device is one example of the manner in which the components may be arranged. Many variations are possible to including different components and different arrangements of those components. The invention is not limited to any particular set of components nor to any particular combination of those components. Advances in computing device technology may result in certain components being replaced by others which perform the same function. Such a device could also embody the invention.

The mobile device 101 includes an operating system (OS) 201 which is stored in a Read Only Memory (ROM) portion of memory 110. The OS may be the Symbian OS developed by Nokia Corporation of Espoo, Finland. The device also includes other software applications which may be stored in ROM or which may be stored in the storage device 118. The application processor 108 is arranged to execute instructions of the OS and of the applications. Execution of these instructions causes mobile device 101 to carry out particular functions by controlling the various hardware components of the device.

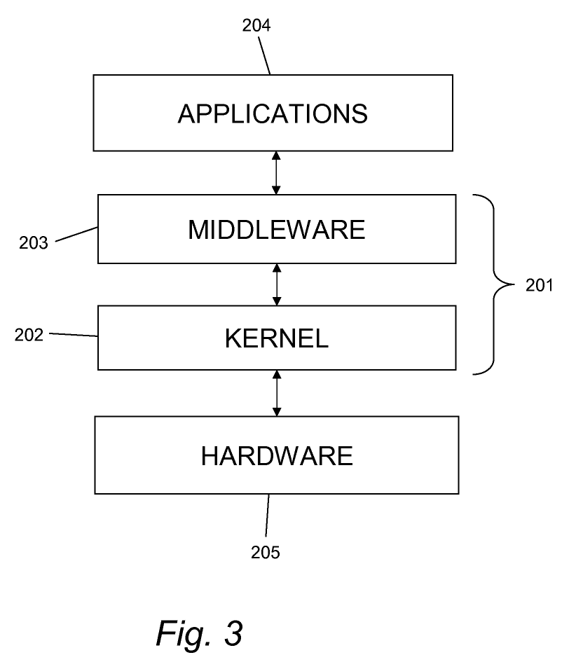

FIG. 3 is a functional diagram showing the logical links between software and hardware components of the device 101. The operating system 201 includes a kernel 202 and a middleware section 203. The kernel 202 is arranged to manage the mobile device's 101 hardware and communications between hardware and software stored on the device. The middleware 203 controls communication between applications running on the device and the system resources. The mobile device 101 has a number of applications 204 stored in memory 110 or storage device 118. These applications may be part of the operating system 201 or may be third-party applications. Each of the applications may access computing resources through the middleware section 203. FIG. 3 also show a number of items of hardware 205. As can be seen, the kernel 203 controls access to the hardware 205.

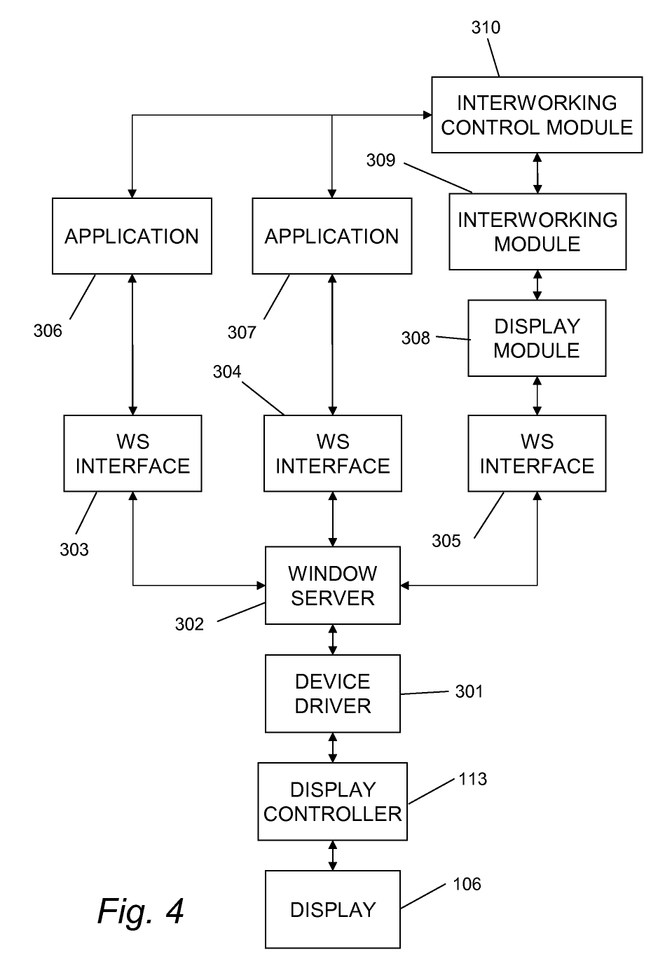

FIG. 4 is a further functional diagram showing the logical links between software and hardware components of the device 101. The device 101 includes the display 106 and the display controller 113. The device also includes a display device driver 301 which is the software interface which provides the OS 201 and other applications with access to the display 106. The OS 201 includes a window server 302 which controls access by the OS and other applications to the display 106. The window server 302 controls and co-ordinates access to the display. For example, drawing may be clipped to an application's visible window. The window server 302 presents an interface to each client application that enables each client application to run without direct interaction with the other applications on the machine. In FIG. 4, three interfaces 303, 304 and 305 are shown. Interfaces 303 and 204 provide access to applications 306 and 307 respectively. These applications may be OS or third-party applications.

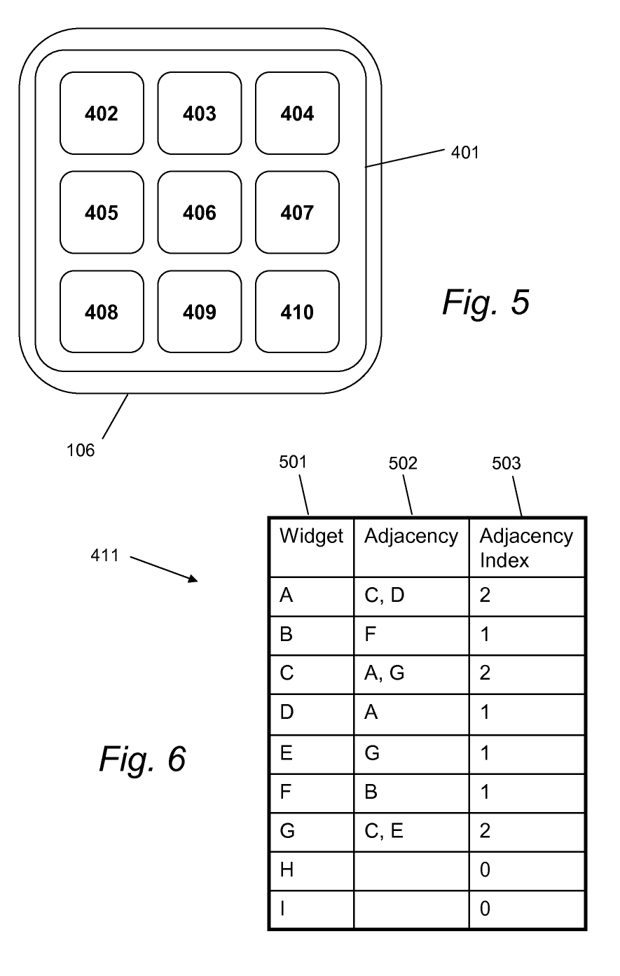

Also shown in FIG. 4 is display module 308. Display module 308 is part of the middleware 203 of the OS 201. The display module 308 is adapted to arrange items on the display of the device. The OS 201 may be adapted to present a so-called “home screen” 401 on the device 101. The home screen 401 is presented to a user of the device, e.g. when the device is switched on, and represents a main view from which users can access the various functions and features of device 101. FIG. 5 shows an example of such a screen. The display 106 is shown displaying home screen 401. The home screen 401 shows a number of so-called “widgets”. Widgets are applications, or application shortcuts, which enable a user to access applications, application functionality or information concerning an application. The home-screen in FIG. 5 shows a video call shortcut 402 (widget A) for video calling a particular person in the user's contacts, a media player shortcut 403 (widget B) to a media player, calendar information 404 (widget C), which shows information from a user's calendar. The home screen 402 also includes a camera widget 405 (widget D) which shows the last image taken on a camera of the mobile device 101, a contacts shortcut 406 (widget E), a radio widget 407 (widget F) which shows the radio station to which the user is currently tuned in to or which the user last listened to and a map widget 408 (widget G) which show the user's current location. The display module 308 controls the arrangement of these widgets on the home screen 401. Finally the home screen 402 shows a last document widget 409 (widget H), which shows the last document used by the user of the mobile device 101, and an audio player widget 410 (widget I).

The widgets displayed on the display 106 may be pre-set or they may be chosen by a user of the mobile device 101. Alternatively, the widgets may be automatically selected based on frequency of use.

As shown in FIG. 4, the device 101 also includes an interworking module 309. The interworking module 309 includes information concerning all of the widgets stored on the device 101. In particular, the interworking module 309 includes information concerning the interworking capability between one widget and all other widgets. This information is called a mapping of widgets. Interworking is the act of one application or widget working with another application or widget. For example, if content from one widget can be used with another widget then those widgets are capable of interworking. This could mean using the content from one widget as the input to a certain function provided by another widget.

An example of a table in the interworking module 309 is shown in FIG. 6. The Figure shows an adjacency table 411 for all widgets displayed on the home screen 401. In column 501, there is a list of the available widgets. Column 502 includes a list of the widgets which are capable of interworking with the widgets listed in column 501. Column 503 provides an adjacency index for each widget. The adjacency index is the number of widgets which any one widget is capable of interworking with. In this example, each widget is allowed to have a maximum adjacency index of two.

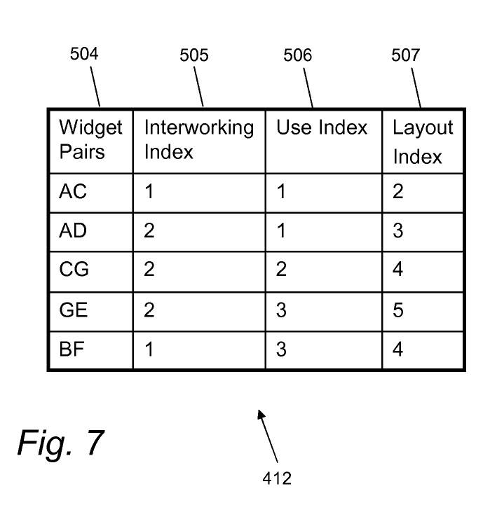

The module 309 also includes an interworking table 412 which is shown in FIG. 7. Column 504 is based on the adjacency information provided in adjacency table 411. It provides a list of all of the pairs of widgets which are capable of interworking. Column 505 is the interworking index. The interworking index provides an indication of the degree of interworking possible between two widgets. The index may be one, two or three with three representing a small degree of interworking and one representing a high degree of interworking. These indices may be pre-set or may be set by a user. Column 506 is a use index. The use index provides an indication of the actual level of interworking used by the user. If a user has not used interworking for a given pair, for example, for more than a week, the pair is given a score of three. A score of one indicates that interworking has been used, for example, in the last 24 hours. A two indicates that interworking has not been used in the last 24 hours, but has been used in the last week. These time limits are examples. Other values can be used and can be redefined by the user or the system over time, for example. Column 507 is a layout index. This index is the interworking index plus the use index and is used to determine adjacency priorities when laying out widgets. An index of two is the lowest score while six is the highest. When placing widgets, priority is placed on low score pairs. As an alternative, widgets can be placed based on use index only, interworking index only, adjacency index only, or any combination of the above.

FIG. 4 also shows an interworking control module 310. The control module 310 maintains the interworking module 309. Whenever a new widget is loaded on to the mobile device 101, the control module 310 generates an entry in the interworking module 309 for that widget. Whether or not a particular widget can interwork with a another widget, and what interworking index is applied to that widget, may be pre-stored. This may take the form of a file which stores details of the interworking relationships between all known widgets. Alternatively it may take the form of an online resource which the control module 310 has access to. In addition to pre-stored information, as user may specify the interworking relationship and index.

As described above, the display module 308 is adapted to arrange widgets on the home screen 401. In this example of the invention, the display module 308 is adapted to use the information contained in the interworking module 309 when arranging widgets on the home screen 401. In particular, the display module 308 is adapted to determine which of the widgets to be displayed are capable of interworking and what the index of each relationship is. The display module 308 will then display those widgets capable of interworking next to each other, placing priority on those widgets with a lower layout index.

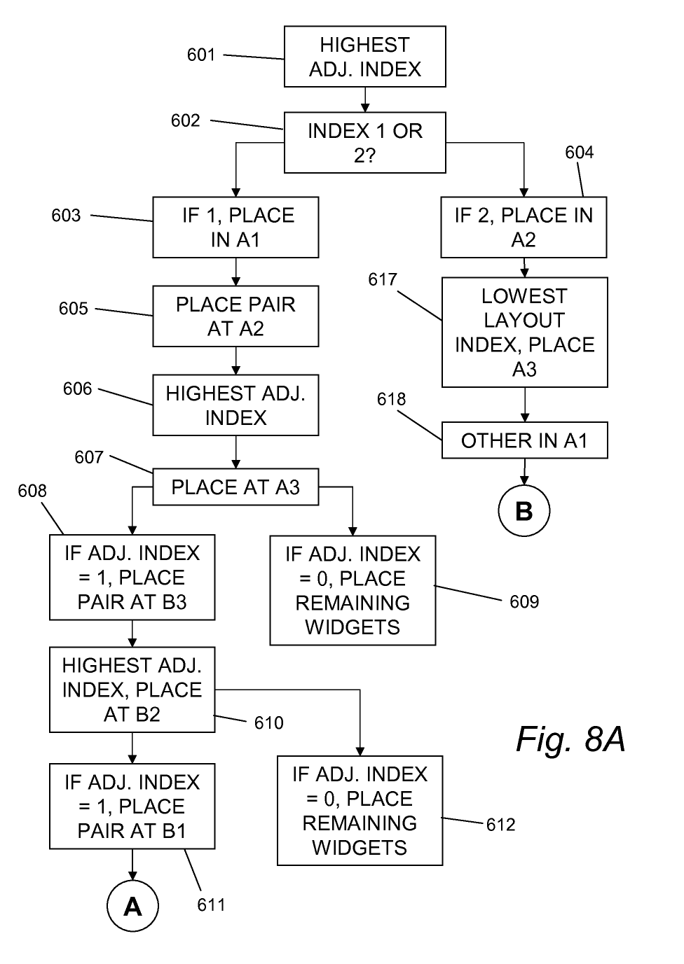

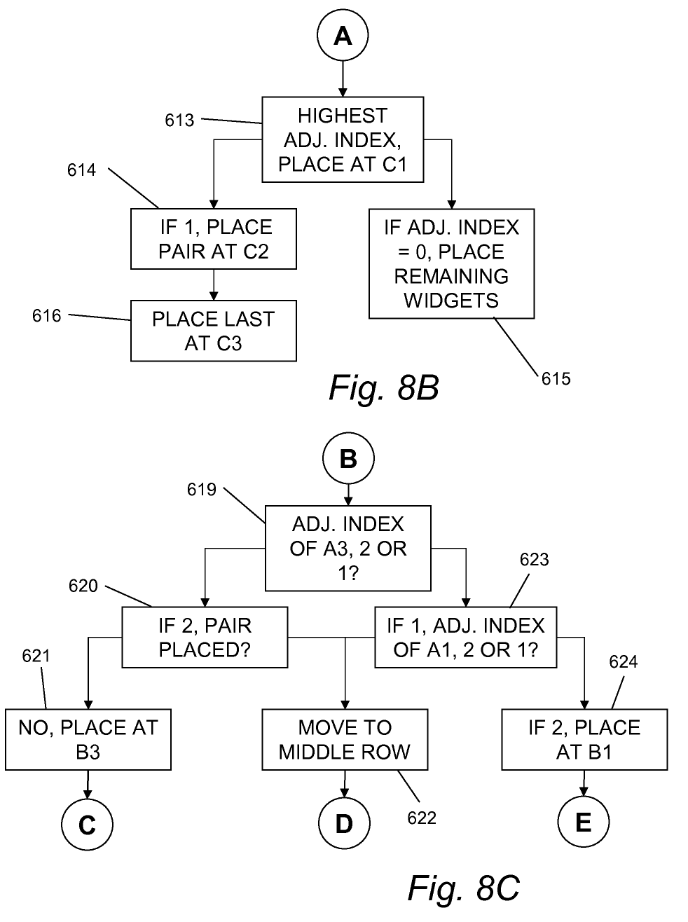

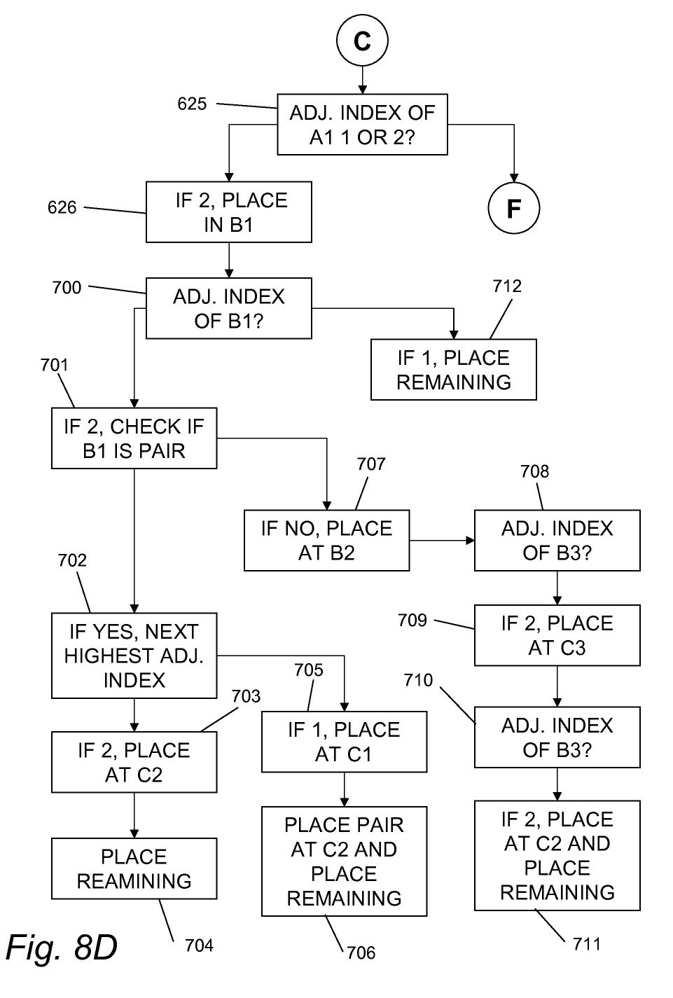

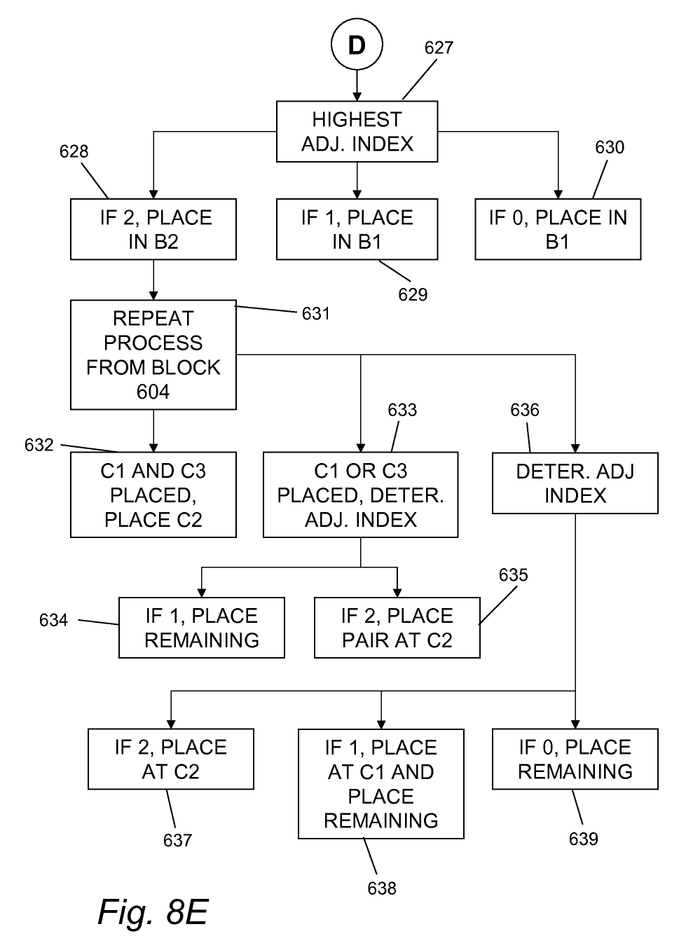

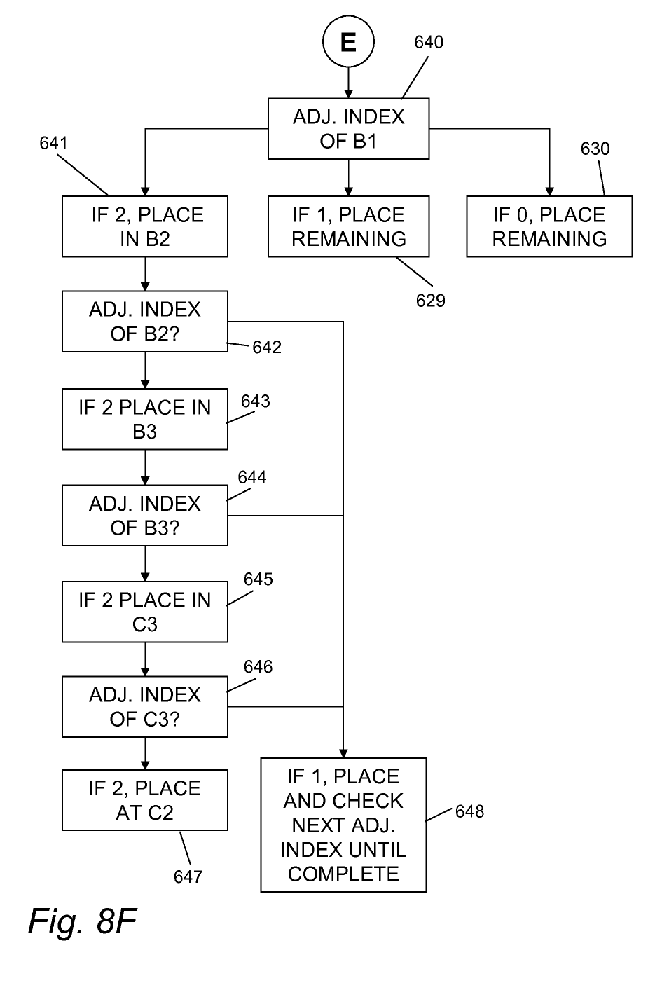

Using the information in the tables, the display module 308 can determine which widgets to place next to which widgets using graph theory. Each widget can be considered to be a node whilst each pair relationship can be considered to be an edge. The edges are weighted based on the layout index. The process used by the display module 308 in order to determine the best layout for a set of nine widgets in a three by three layout will now be described with reference to FIG. 8.

The adjacency table includes all widgets which are to be displayed on the home screen 401. The display module 308 chooses the widget which has the most interworking connections using the adjacency table (block 601). In the event that two widgets have the same adjacency index, the widget with the lowest associated edge weights (layout index) is chosen. The display module 308 determines whether the adjacency index is one or two (block 602). The display module 308 determines where to place the chosen widget on a three by three based on the adjacency index. If the adjacency index is one, the widget is placed in position A1 (block 603). If the adjacency index is two, the widget is placed in position A2 (block 604). This arrangement provides the best chance of placing widgets with high adjacency index and high layout index close together.

If the widget has an adjacency index of one, and is placed in position A1, the widget with which it is paired (as indicated by the interworking table 412) is placed in position A2 (block 605). Because the widget placed in position A1 has the highest adjacency index, that index being one, the widget placed in position A2 must also have an index of one. The display module 308 therefore chooses a new widget to place on the grid from the adjacency table 411. The display module 308 chooses the widget, listed in the interworking table 412, with the next highest adjacency index (step 606). Regardless of the adjacency index of the widget, it is placed in position A3 (block 607). If the widget placed in A3 has an adjacency index of one (it cannot be higher than one), the widget it is paired with is placed in position B3 (block 608). If the widget in A3 has an adjacency index of zero, the display module 308 places the remaining widgets in any order in the remaining grid squares (block 609). The order does not matter at this stage, because none of the remaining widgets are capable of interworking. If the widget placed in position A3 had an index of one, then display module 308 determines the next widget with the highest adjacency index and places it in position B2 (block 610). If this widget has an adjacency index of one, then the widget it is paired with is placed in position B1 (block 611). If the adjacency index is zero, the remaining widgets are placed in any order (block 612). The widget with the next highest adjacency index is placed in position C1 (block 613). If its adjacency index is one, the other widget of the pair is placed in position C2 (block 614). If the adjacency index of the widget in position C1 is zero, the remaining widgets are placed in any order (block 615). If the widget in position C1 does have an adjacency index of one, then the remaining widget is placed in position C3 (block 616).

If the widget placed in position A1 had an adjacency index of two, it would have been placed in position A2, as can be seen at block 604. In this case, the display module 308 selects the widget to which the first widget is paired with the lowest layout index (block 617). This widget is placed in position A3, with the other paired widget placed in position A1 (block 618). In the event that both pairs have the same layout index, then they would be placed top right and top left in any order. The display module 308 then determines whether the adjacency index of the widget in position A3 is two (which is the highest it could be) or one (block 619). If it is two, the display module 308 determines, from the interworking table 412, whether the widget it is paired with is already placed (it could only be the widget in position A1) (block 620). If the paired widget is not placed, the display module 308 places the other widget it is paired with below it in position B3 position (block 621). If the other widget of the pair is the widget in position A1, then the display module 308 chooses another widget from the adjacency table 411 to place (block 622), as will be described below. This is because the widget positioned in location A1 must also have an adjacency index of two, and it will be a paired with the widget in position A3. If the adjacency index of the widget in position A3 is one, the adjacency index of the widget in position A1 is determined (block 623). If the adjacency index is two, the display module 308 places the other widget it is paired with below it in position B1 (block 624). If the adjacency index is one, then the display modules 308 chooses another widget from the adjacency table 411 to place (block 622). At block 621, the display module places the widget paired with the widget at B3. The display module 308 checks the adjacency index of the widget in position A1 (block 625). If it has an index of two, the widget it is paired with is placed in position B1 (block 626). If it has an index of one, nothing is placed.

As a result of this process, the grid may have no widgets placed across the middle row (block 622), one widget in either the position B1 (block 624) or B3 (block F), or widgets in both positions B1 and B3 (block 626).

In the event that no widgets are placed across the middle (block 622), the display module 308 determines the widget in the table with the next highest adjacency index (block 627). This may be two, one or zero. The widget is placed as follows:

If adjacency index=2, position B2 (block 628);

If adjacency index=1, position B1 (block 629); and

If adjacency index=0, position B1 (block 630).

If there is more than one widget with an index of two or one, the widget with the lowest associated layout index is placed first. If the widget has an index of two, it is placed in position B2 and the process described above in connection with the widget placed at position A2 is repeated (block 631). In this case, the paired widgets are placed in positions B1 and B2. Following this process, the bottom row of the grid may either be empty, have a widget in either position C1 or C3, or in both positions C1 and C3. If there are widgets in positions C1 and C3, the one remaining widget is placed in position C2 and the grid is complete (block 632). If there is a widget in positions C1 or C3, the adjacency index of that widget is determined (block 633). It may be two or one. If it is one, the remaining two widgets are placed in the remaining two grid positions, in any order, and the grid is complete (block 634). If it is two, the widget that is paired with the widget in C1 or C3 is placed in C2 with the remaining widget placed in position C1 or C3 respectively (block 635). If there are no widgets on the bottom row, the display module 308 determines the widget with the next highest adjacency index (block 636). If the adjacency index is two, that widget is placed in position C2 and two remaining widgets are placed either side of it (block 637). If the adjacency is one, the widget is placed in position C1 and the widget it is paired with is placed in position C2. The one remaining widget is then placed in position C3 (block 638). If the adjacency is zero, the remaining widgets are placed in a any order along the bottom row (block 639). The grid is then complete.

At block E, one widget is placed in the position B1. The display module 308 determines the adjacency index of that widget (block 640). If it is two, then the widget it is paired with is placed in position B2 (block 641). The adjacency index of the widget at B2 is then determined (block 642). If it is two, the widget it is paired with is placed at position B3 (block 643). The adjacency index of the widget in position B3 is then determined (block 644). If it is two, then the widget it is paired with is placed at C3 (block 645). The adjacency index of the widget at C3 is then determined (block 646). If it is two, then the widget it is paired with is placed at C2, the last widget is placed at C1 and the grid is complete (block 647) If at blocks 642, 644 and 646, the adjacency index is one, the display module 308 places the widget with the next highest adjacency score in B3, C3 and C2 respectively and repeats as above until the grid is complete (block 648).

If the middle row contains a single widget paired with the top row in position B3 (block F), the above process is repeated in the opposite direction.

At block 626, the middle row has a widget in positions B1 and B3. The display module 308 determines the adjacency index of the widget in position B1 (block 700). If the adjacency index is two, the display module 308 determines whether or not the widget in position B3 is the other one of the pair (block 701). If so, the display module 308 determines the unplaced widget with the next highest adjacency score (block 702). If the score is two, the display module 308 places the widget in position C2 (block 703). The two paired widgets are placed in positions C1 and C3 and the one remaining widget is placed position B2 (block 704). If the next widget has an index of one, it is placed in position C1 and its pair placed in position C2 (block 705). The remaining two widgets are placed in positions B2 and C3 and the grid is complete (block 706).

If the pair of the widget at B1 is not the widget at B3, the display module 308 places it in position B2 (block 707). The display module 308 then determines the adjacency index of the widget at position B3 (block 708). If it is two, it places the widget in position C3 (block 709). The display module 308 then determines the index of the widget in position B2 (block 710). If it is two, it places the widget it is paired with in position C2 (block 711).

At block 700, the adjacency index of B1 may be one (block 712). If this is the case, the remaining widgets are placed in any order.

The application of the above process to the information show in tables 411 and 412 will now be described. The display module 308 uses the information in adjacency table 411 to determine which widget has the most interworking connections. In the present case, widgets A 402, C, 404 and G 408 have the highest adjacency indices and of those widgets, widget A 402 has the lowest associated layout index. Processing therefore begins with widget A 402. The display module 308 determines where to place widget A on the home screen 401 based on the adjacency index. In the present case, widget A 402 has an adjacency index of 2 and is placed in position A2 on the home screen 401 (block 603). The display module 308 then determines where to place the widgets which are paired with widget A, as indicated by table 412.

The display module begins processing the paired widget with the lowest layout index. Pair AC has a layout index of 2 and C is placed in A3. Widget D is placed in A1. C is processed next as it has the highest adjacency index of A and D. As C has an adjacency index of two, its paired widget (G) is placed at B3. As G has an adjacency index of 2, it's other paired widget (widget E) is placed at B2. The widget with the next highest adjacency index is widget B. It has an adjacency index of one and is paired with widget F. These widgets are placed in positions B1 and C1 respectively. Finally, widgets H and I are placed in positions C2 and C3. The grid is then complete.

The interworking control module 310 is adapted to maintain a list of widgets to be displayed on the home screen 401. The device 101 may have a large number of widgets which can be displayed on the display. The control module 310 can update the list of displayed widgets manually or automatically.

In the above described example, the home screen layout is determined for a 3×3 widget layout. Other layouts are possible, including, for example, a 4×3 layout and a layout in which widgets of different sizes can be displayed. Other ways of determining the best layout are also possible and the process described above is not intended to limit the invention. The above described examples relate to the use of adjacency index and layout index. In another example, the adjacency index is not used. Instead, only the layout index is used. The widget with the widget pair with the lowest layout index is placed first. Any widgets paired with those widgets are placed next, based on lowest layout index. In this manner, the home screen is laid out in such a way that preference is given to the layout index, rather than the adjacency index.

The above examples of the invention describe a software implementation of the invention. Other examples of the invention include a hardware only implementation and a hardware and software implementation. A example of the invention includes a component on a chip which provides the functionality described above in connection with the software implementation. The display module, interworking module and interworking control module may each be implemented as hardware and software.

An example of the invention is an apparatus as defined in the claims. This apparatus may be a component provided as part of a chip on an electronic circuit board. Alternatively the apparatus may be a chip on an electronic circuit board. As a further alternative, the apparatus may be a computing device, such as a mobile phone. The features defined in the claims may be implemented in hardware. Alternatively, the features may be implemented using software instructions which may be stored in a memory provided on the component, chip or computing device.

A further example of the invention provides an apparatus having means for displaying a plurality of elements on a display of a computing device; and means for storing relationship information concerning relationships between each of said elements; wherein the means for displaying may also arrange the elements on the display in accordance with said relationship information. The means for displaying may be a processor which may provided as a component on an electronic circuit board.

The above example of a way to arrange widgets on a display may be carried out at regular intervals or when prescribed by the user. Alternatively, the process may be carried out each time a user uses interworking. This may be a benefit as the layout index, which can influence position, may change from time-to-time.

The term interworking can mean pre-assigned information concerning the ability of two applications to interwork. Alternatively, it can mean information based on actual interworking patterns of a user. Interworking can mean that user can start a certain task in one application and continue it in another application. Alternatively, interworking can define the ability of two applications to move information between them.

In a further example, the degree to which a specific widget is used, by itself, may be used to determine which widgets to place first. For example, the widget used the most may be placed first. Then the widget pairs with the layout index are placed.

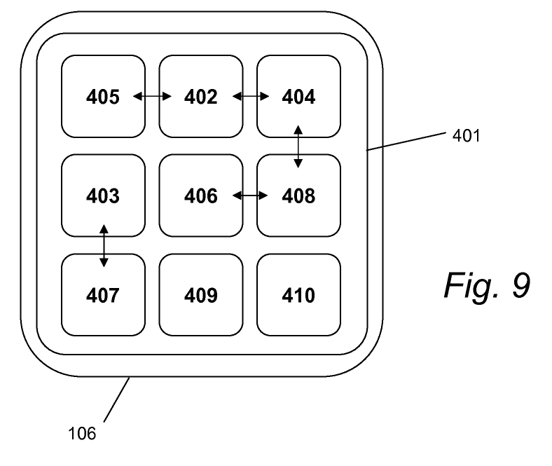

An example of the invention may also be a computing device substantially as described hereinbefore and as shown in FIGS. 1 to 9.

In an example of the invention, the display module displays elements on the display. An element may be a widget, an application, an icon, content from an application or database or other information. An element may be an area of the display which is used to represent any of the above. Elements may be related in the manner described above in connection with widgets and may be arranged on the display in accordance with that relationship information.

The above example has been described in the context of a home-screen for a computing device. The invention may also be applied to other screens and windows of a computing device. An application may display a number of elements which are able to interact with each other. For example, a contacts application may have a list of contacts with each contact being displayed as an element. The application may also include options for contacting a contact, either by text, email or call. Each of these functions may be displayed as an element. These elements may interact with each other. A user may drag a contact on to a call element to initiate a call. The elements therefore have relationship information stored on the device which enables the elements to be arranged on the display in accordance with the relationship information.

Various modifications, changes, and/or alterations may be made to the above described examples to provide further examples which use the underlying inventive concept, falling within the spirit and/or scope of the invention. Any such further examples are intended to be encompassed by the appended claims.

1. An apparatus comprising:
a display module adapted to display a plurality of elements on a display of a computing device; and
an interworking module adapted to store relationship information concerning relationships between each of said elements; wherein
the display module is further adapted to arrange said elements on said display in accordance with said relationship information.

2. An apparatus according to claim 1, wherein said relationship information includes interworking information.

3. An apparatus according to claim 1, wherein said relationship information includes information concerning the number of elements with which an element may interwork.

4. An apparatus according to claim 2, wherein said interworking information includes pre-stored information regarding an element's ability to interwork with another element.

5. An apparatus according to claims 2, wherein said interworking information includes information concerning the degree to which a user uses interworking between two elements.

6. An apparatus according to claims 2, wherein said interworking information includes a layout index.

7. An apparatus according to claim 1, wherein said elements are widgets.

8. A computing device comprising the apparatus of claim 1, further comprising:
a display, adapted to display said elements;
a memory, adapted to store said display module and said interworking module as instructions; and
a processor, adapted to carry out said instructions.

9. A computing device according to claim 8, wherein said display is a touch screen display which is an input device to said computing device.

10. A computing device according to claim 9, wherein said device is a mobile phone.

11. A method comprising:
storing relationship information concerning a relationship between each of a plurality of elements;
displaying a plurality of said elements on a display; and
arranging said elements on said display in accordance with said relationship information.

12. A method according to claim 11, wherein said relationship information includes interworking information.

13. A method according to claim 12, further comprising arranging those elements most suitable for interworking in preference to those less suitable.

14. A method according to claim 11, wherein said relationship information includes information concerning a number of interworking connections.

15. A method according to claim 14, further comprising arranging those elements having the most interworking connections in preference to those with less interworking connections.

16. A method according to claim 12, wherein said interworking information includes pre-stored information regarding an element's ability to interwork with another element.

17. A method according to claim 12, wherein said interworking information includes information concerning the degree to which a user uses interworking between two elements.

18. A method according to claim 12, further comprising determining a layout index, based on said interworking information.

19. A computer program or suite of computer programs arranged such that when executed by a computer they cause the computer to operate in accordance with the method of any of claims 11 to 16.

20. A computer-readable storage medium encoded with instruction that, when executed by a computer, perform: the method according to any of claims 11 to 16.
